(19) United States
(12) Patent Application Publication
(10) Pub. No.: US 2026/0229193 A1
(43) Pub. Date: Aug. 6, 2026

(54) SOURCE-SIDE SYNCHRONIZATION OF FRAME UPDATES FOR DISPLAYS

(71) Applicant: Intel Corporation, Santa Clara, CA (US)

(72) Inventors: Vishal Ravindra Sinha, Portland, OR (US); Krishna Kishore Nidamanuri, Bangalore (IN); Perazhi Sameer Kalathil, Folsom, CA (US); Roland P. Wooster, Folsom, CA (US); Geethacharan Rajagopalan, Gold River, CA (US)

(21) Appl. No.: 19/631,430

(22) Filed: Mar. 27, 2026

(51) Int. Cl. G09G 3/3283

(52) U.S. Cl. CPC G09G 3/3283; G09G 2310/08

(57) ABSTRACT

Systems and methods for source-side variable refresh rate (VRR) synchronization for organic light-emitting diode (OLED) displays are described. A processor may determine a number of emission cycles since a previous frame update based on emission cycle information of a display. The processor may determine a time delay based on the number of emission cycles and may provide a next frame to the display based on the time delay to align the next frame with an emission cycle boundary of the display. The time delay may be determined based on whether the number of emission cycles is an integer and whether the number of emission cycles is less than a number of emission cycles per frame. Source-side synchronization may enable VRR operation on OLED displays without requiring frame buffer hardware in the display timing controller.

### BACKGROUND

Display technologies continue to evolve to meet increasing demands for visual quality and power efficiency. Organic light-emitting diode (OLED) displays offer advantages in contrast, color accuracy, and response time compared to liquid crystal display (LCD) technologies. OLED displays operate using emission cycles where organic molecules are electrically excited to emit light in discrete pulses at frequencies higher than the display frame rate. Variable refresh rate (VRR) operation allows displays to dynamically adjust their refresh rate to match content, reducing visual artifacts such as screen tearing during gaming and video playback. However, VRR operation on OLED displays presents timing challenges because frame updates may arrive at times that do not align with emission cycle boundaries, potentially causing visual artifacts including flickering and uneven brightness. Approaches to address these timing challenges in OLED displays with VRR capability involve various tradeoffs between cost, complexity, and visual quality.

### BRIEF DESCRIPTION OF FIGURES

The accompanying drawings further serve to explain non-limiting and non-exhaustive examples, the principles described, and to enable a person skilled in the pertinent art to make and use the techniques discussed herein.

FIG. 1 illustrates a block diagram of an example Organic light-emitting diode (OLED) display system with frame buffering.

FIG. 2 illustrates a block diagram of a system for a software/firmware-based implementation of source-side variable refresh rate synchronization.

FIG. 3 illustrates a block diagram of a system for a hardware-based implementation of source-side variable refresh rate synchronization.

FIGS. 4A-4B illustrate a flowchart of a method for source-side variable refresh rate synchronization.

FIG. 5 illustrates a timing diagram of OLED display operation at a fixed refresh rate.

FIGS. 6A-6B illustrate a timing diagram of variable refresh rate synchronization with frame and emission cycle alignment.

The following description will be described with reference to the accompanying drawings. The drawing in which an element first appears is typically indicated by the leftmost digit(s) in the corresponding reference number.

### DETAILED DESCRIPTION

The following description sets forth exemplary aspects and is not intended as a limitation on the scope. Rather, the description also encompasses combinations and modifications to those exemplary aspects described herein.

Display systems and methods for variable refresh rate operation are described, including to source-side synchronization of frame updates with organic light-emitting diode (OLED) emission cycles. For example, display systems and methods for synchronizing variable refresh rate (VRR) frame updates with organic light-emitting diode (OLED) emission cycles are described. OLED displays may operate using emission cycles as a light generation mechanism, where each pixel produces light through discrete emission events. During an emission cycle, organic molecules may be electrically excited to emit photons and then return to a ground state. Emission cycles may operate at frequencies higher (e.g., multiple times higher) than a display frame rate, such as 960 Hz emission cycles for a 120 Hz frame rate.

Variable refresh rate operation may allow frame updates to occur at varying intervals rather than at fixed intervals. During VRR operation, new frames may arrive at times that do not align with emission cycle boundaries of an OLED display. If frame updates occur in the middle of an emission cycle, visual artifacts such as screen tearing, flickering, or uneven brightness may result. The timing relationship between frame updates and emission cycles may be characterized by the number of emission cycles that have elapsed since a previous frame update. If the elapsed time corresponds to a whole number (e.g., integer) of emission cycles, the frame update may align with an emission cycle boundary. If the elapsed time corresponds to a non-whole number (e.g., non-integer) of emission cycles, the frame update may fall between emission cycle boundaries, indicating that a partial emission cycle has elapsed since the last complete emission cycle boundary. Additionally, the number of elapsed emission cycles may be compared to a number of emission cycles per frame to determine whether the frame update is within a single frame period or beyond the frame period. The number of emission cycles per frame may be based on the emission cycle frequency and a frame rate of the display. If the number of elapsed emission cycles is less than the number of emission cycles per frame, the frame update may be within a single frame period. If the number of elapsed emission cycles is greater than or equal to the number of emission cycles per frame, the frame update may be beyond the frame period. This comparison may determine whether the time delay aligns the next frame with an end of a current frame period or with a next emission cycle boundary.

Conventional approaches to VRR operation on OLED displays may use a frame buffer within a display timing controller (D-TCON) to align frame updates with emission cycle boundaries. The frame buffer may temporarily store incoming frames and release the frames at the appropriate emission cycle timing. However, such display-side frame buffering requires additional hardware, increasing costs to display manufacturing.

Source-side processing approaches are described for aligning frame timing with emission cycle boundaries without requiring display-side frame buffering hardware. A graphics processor or display engine may calculate timing relationships between frame updates and emission cycles and may delay frame transmission to align with emission cycle boundaries. The graphics processor or display engine may obtain emission cycle information from a display and may determine appropriate delays based on elapsed time since a previous frame update, emission cycle frequency, and hardware processing delays. Such source-side synchronization may enable VRR operation on OLED displays while reducing display hardware costs.

OLED displays operating with variable refresh rate may face timing challenges when frame updates do not align with emission cycle boundaries. Because OLED panels operate using discrete emission cycles at frequencies such as 960 Hz, frame updates arriving mid-cycle may cause visual artifacts including flickering and uneven brightness. Conventional approaches may address this timing misalignment by incorporating a frame buffer within a display timing controller. The frame buffer may store incoming frames and release the frames at appropriate emission cycle timing, ensuring proper alignment between frame updates and emission cycles.

The inclusion of a frame buffer within a display timing controller may add manufacturing cost to OLED displays. This additional cost may affect OLED display pricing across market segments, including both mainstream and premium segments. In mainstream market segments, the frame buffer cost may prevent OLED displays from achieving price points competitive with liquid crystal display (LCD) alternatives. In premium market segments, the frame buffer cost may reduce profit margins or limit price competitiveness relative to other display technologies.

Source-side VRR synchronization may address the timing alignment challenge without requiring a frame buffer in the display timing controller. A graphics processor or display engine may calculate timing delays to align frame updates with emission cycle boundaries of an OLED display. The graphics processor or display engine may obtain emission cycle information from the display, determine elapsed time since a previous frame update, and calculate an appropriate delay to ensure the next frame arrives at an emission cycle boundary. By performing synchronization calculations at the source side, the frame buffer in the timing controller (TCON) may be eliminated.

Elimination of the frame buffer from the display timing controller may reduce manufacturing costs for OLED displays. The cost reduction may apply across market segments, enabling improved price competitiveness for OLED displays in both mainstream and premium segments. In mainstream segments, the reduced manufacturing cost may enable OLED displays to achieve price points suitable for cost-sensitive applications. In premium segments, the reduced manufacturing cost may improve profit margins or enable more competitive pricing relative to alternative display technologies.

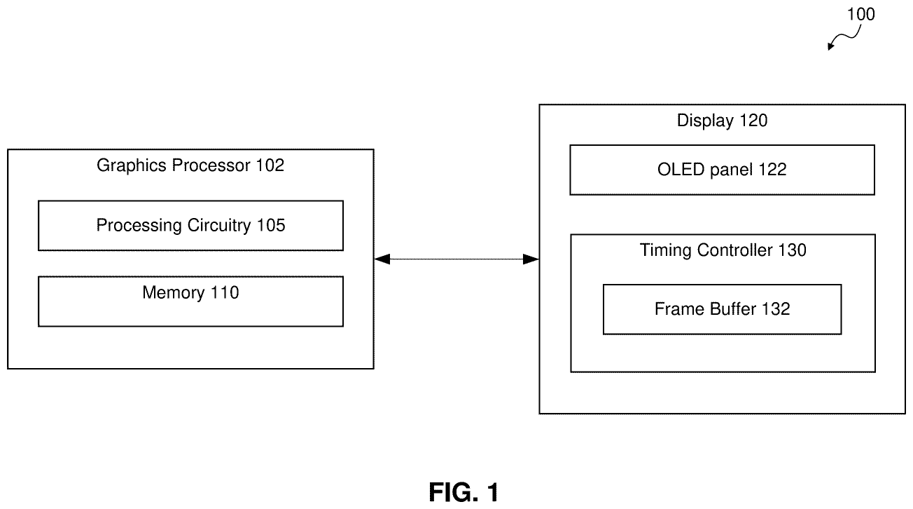

Referring to FIG. 1, a system 100 depicts an example OLED display configuration with frame buffering. The system 100 may include a graphics processor 102 and a display 120 that are communicatively coupled to one another. The graphics processor 102 may communicate with the display 120 through a bidirectional connection, allowing frame data to be transmitted from the graphics processor 102 to the display 120 and allowing display information to be communicated from the display 120 to the graphics processor 102.

The graphics processor 102 may include processing circuitry 105 and memory 110. The processing circuitry 105 may be configured to generate frame data for display and manage the timing of frame updates. The memory 110 may store frame data and other information used by the processing circuitry 105 during graphics processing operations. The processing circuitry 105 may retrieve frame data from the memory 110 and transmit the frame data to the display 120 for rendering.

With continued reference to FIG. 1, the display 120 may include an OLED panel 122 and a timing controller 130. The OLED panel 122 may be an organic light-emitting diode panel that produces visual output through emission cycles. The OLED panel 122 may operate at an emission cycle frequency that is higher than a frame rate of the display 120, such as 960 Hz emission cycles for a 120 Hz frame rate. The timing controller 130 may manage the timing of frame updates to the OLED panel 122.

The timing controller 130 may include a frame buffer 132. The frame buffer 132 may temporarily store incoming frames from the graphics processor 102 and release the frames at appropriate emission cycle timing to prevent visual artifacts during variable refresh rate operation. If a frame arrives from the graphics processor 102 at a time that does not align with an emission cycle boundary of the OLED panel 122, the frame buffer 132 may hold the frame until an appropriate emission cycle boundary occurs. The frame buffer 132 may then release the frame to the OLED panel 122 at the emission cycle boundary, ensuring proper alignment between frame updates and emission cycles.

In the configuration shown in FIG. 1, the frame buffer 132 within the timing controller 130 may align frame updates with emission cycle boundaries of the OLED panel 122. The frame buffer 132 may hold new frames and release the frames at the correct emission cycle timing, which may enable variable refresh rate operation without visual artifacts such as screen tearing or flickering.

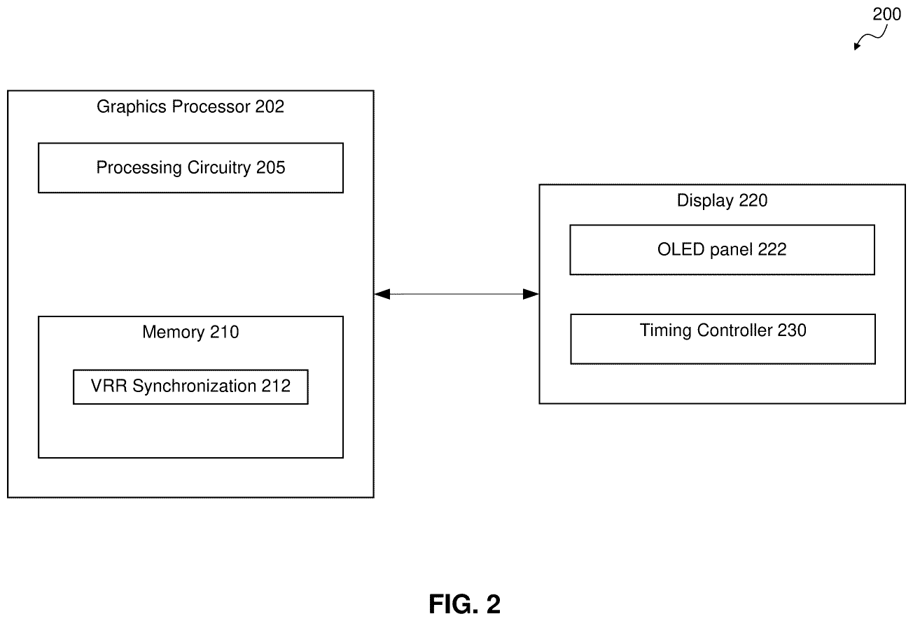

Referring to FIG. 2, a system 200 for source-side variable refresh rate synchronization for OLED displays is shown. The system 200 may include a graphics processor 202 and a display 220 that are communicatively coupled to each other. The graphics processor 202 may communicate with the display 220 through a bidirectional connection, allowing the graphics processor 202 to send frame data to the display 220 and receive timing information from the display 220.

The graphics processor 202 may include processing circuitry 205 and memory 210. The processing circuitry 205 may be configured to perform frame generation and display operations. The memory 210 may store VRR synchronization 212, which may contain instructions or data for aligning frame updates with emission cycles of the display 220. VRR synchronization 212 stored in the memory 210 may enable the processing circuitry 205 to calculate appropriate delays for frame updates based on emission cycle timing information obtained from the display 220. The memory may additionally or alternatively store other data and/or information.

With continued reference to FIG. 2, the display 220 may include a panel, such as OLED panel 222, and a timing controller 230. The OLED panel 222 may produce visual output through emission cycles operating at an emission cycle frequency. The timing controller 230 may manage the timing of pixel updates to the OLED panel 222. The system 200 differs from the system 100 of FIG. 1 in that the timing controller 230 may omit a frame buffer. The synchronization of frame updates with emission cycles may be performed by the graphics processor 202 using VRR synchronization 212 rather than by buffering frames within the display 220. While the illustrated example omits the frame buffer, one or more aspects may combine the VRR synchronization operations with one or more frame buffers.

VRR synchronization 212 may be implemented in graphics driver software and/or firmware to perform VRR synchronization calculations and frame timing alignment. If implemented in graphics driver software, VRR synchronization 212 may comprise software instructions that may be executed by the processing circuitry 205. If implemented in firmware, VRR synchronization 212 may comprise firmware instructions (stored in the memory 210) that may be executed by the processing circuitry 205.

The memory 210 may store instructions that, if executed by the processing circuitry 205, cause the graphics processor 202 to determine, based on emission cycle information of the display 220, a number of emission cycles since a previous frame update. The emission cycle information may comprise an emission cycle frequency of the display 220. The emission cycle frequency may be of the OLED panel 222 of the display 220. The processing circuitry 205 may determine a time delay based on the number of emission cycles. The processing circuitry 205 may provide, based on the determined time delay, a next frame to the display 220 to align the next frame with an emission cycle boundary of the display 220.

VRR synchronization 212 may include instructions that cause the graphics processor 202 to determine a number of elapsed emission cycles since a previously provided frame based on an elapsed time since the previously provided frame and the emission cycle frequency of the display 220. VRR synchronization 212 may further include instructions that cause the graphics processor 202 to determine a number of emission cycles per frame based on the emission cycle frequency and a frame rate of the display 220. The graphics processor 202 may determine a time delay based on the number of emission cycles elapsed and the number of emission cycles per frame. The graphics processor 202 may provide, based on the time delay, the next frame to the display 220 to align the next frame with an emission cycle boundary of the display 220.

VRR synchronization 212 may be stored on a non-transitory computer-readable medium within the memory 210. The non-transitory computer-readable medium may store instructions that, if executed by the processing circuitry 205, cause the graphics processor 202 to perform the frame timing alignment operations described above. By storing VRR synchronization 212 in the memory 210 and executing the instructions using the processing circuitry 205, the system 200 may enable variable refresh rate operation on the OLED panel 222 without requiring a frame buffer in the timing controller 230.

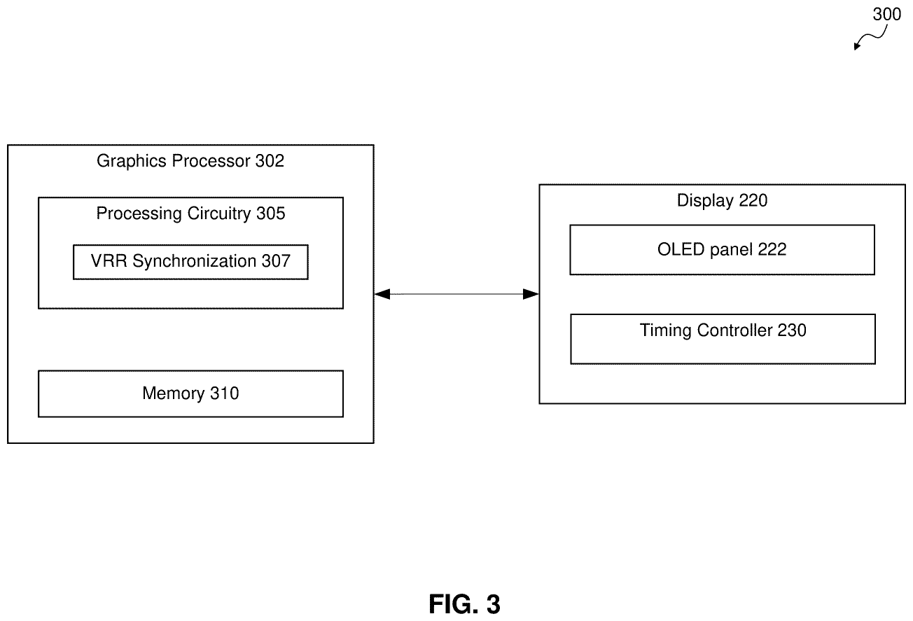

Referring to FIG. 3, a system 300 for source-side variable refresh rate synchronization for OLED displays with hardware-based implementation is shown. The system 300 may include a graphics processor 302 and the display 220 that are communicatively coupled to each other. The graphics processor 302 may communicate with the display 220 through a bidirectional connection, enabling communication between the graphics processor 302 and the timing controller 230.

The graphics processor 302 may include processing circuitry 305, VRR synchronization 307, and memory 310. The processing circuitry 305 may handle frame generation and display operations. VRR synchronization 307 may implement a timing alignment algorithm that calculates delays to synchronize frame updates with emission cycles of the OLED panel 222. VRR synchronization 307 may be implemented in dedicated hardware logic within the graphics processor 302, providing hardware-based synchronization capabilities. For example, if implemented in Graphics Processing Unit (GPU)/display engine (DE) hardware, the VRR synchronization 307 may comprise dedicated hardware logic within the processing circuitry 305. The memory 310 may store frame data and timing information used by the processing circuitry 305 and VRR synchronization 307.

With continued reference to FIG. 3, the display 220 may include the OLED panel 222 and the timing controller 230. The timing controller 230 may receive frame data from the graphics processor 302 and control the OLED panel 222 to display the received frames. The system 300 may enable variable refresh rate operation by performing synchronization calculations at the graphics processor 302 rather than requiring a frame buffer within the display 220, thereby reducing display hardware costs while maintaining visual quality during variable refresh rate operation.

The software/firmware-based VRR synchronization of the system 200 of FIG. 2 may be combined with the hardware-based VRR synchronization of the system 300 of FIG. 3. For example, a graphics processor may include both VRR synchronization instructions stored in memory and dedicated hardware logic for performing timing alignment calculations. Such a hybrid implementation may leverage the flexibility of software/firmware-based synchronization with the performance of hardware-based synchronization. The specific allocation of synchronization operations between software/firmware and hardware may vary based on implementation requirements.

The VRR synchronization 307 may include a timing circuit configured to track an elapsed time since a previous frame was provided to the display 220. The timing circuit may include a timestamp register that stores a timestamp of a last frame update and a counter or timer that measures elapsed time relative to the stored timestamp. The VRR synchronization 307 may further include a delay register configured to store the calculated time delay value, and a comparator circuit configured to determine whether the number of elapsed emission cycles is an integer and whether the number of elapsed emission cycles is less than a number of emission cycles per frame. The VRR synchronization 307 may also include a synchronization register configured to store emission cycle frequency information received from the display 220 (e.g., through EDID or DPCD communication). In the software/firmware implementation of FIG. 2, the timing circuit, delay register, comparator circuit, and synchronization register functions may be performed by the processing circuitry 205 executing the VRR synchronization 212 instructions stored in the memory 210.

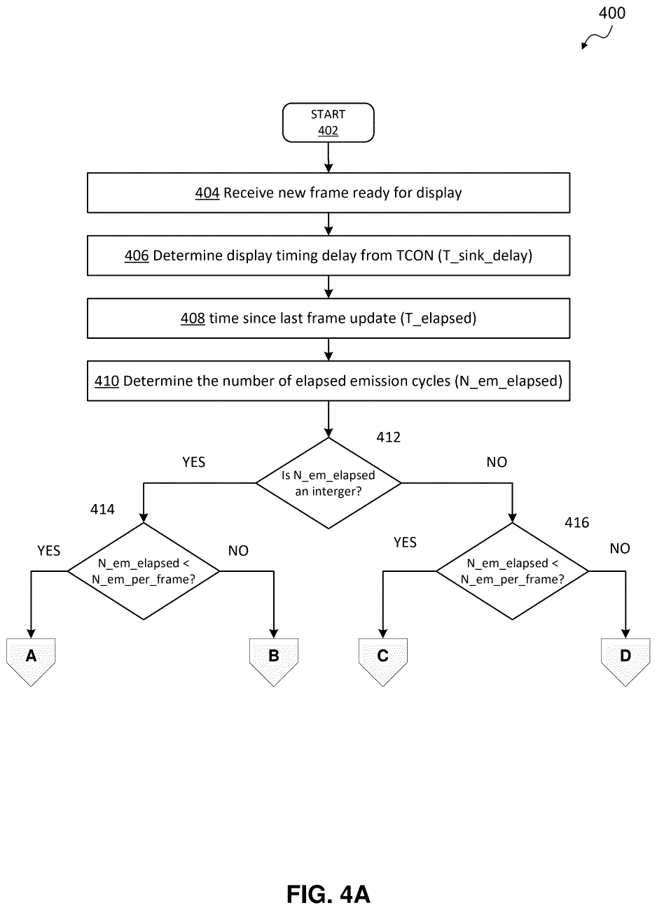

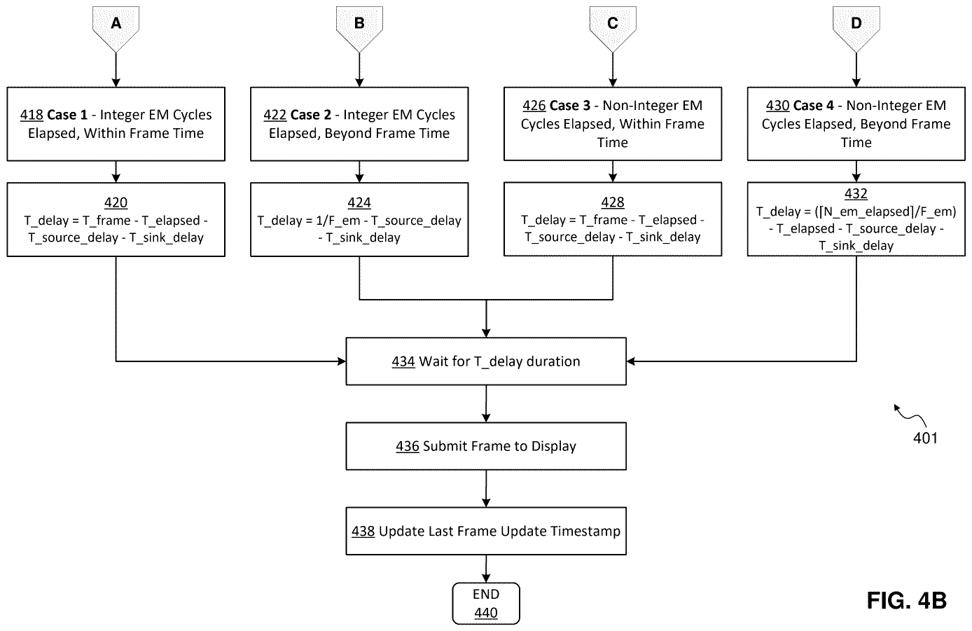

The source-side VRR synchronization described with reference to FIGS. 2 and 3 may provide several advantages. The VRR synchronization (e.g., VRR synchronization 212 or VRR synchronization 307) may enable variable refresh rate operation on OLED displays without requiring a frame buffer in the timing controller 230, which may reduce display manufacturing costs. The case-based delay calculation logic, as described in further detail with reference to FIGS. 4A-4B, may prevent visual artifacts such as screen tearing, flickering, and uneven brightness during variable refresh rate operation by aligning frame updates with emission cycle boundaries. The communication of emission cycle information from the display 220 to the graphics processor 202 or 302 through communication protocols such as EDID or DPCD may enable the source-side synchronization to obtain timing parameters without requiring additional hardware in the display. The use of existing line buffers in the timing controller 230 may increase timing tolerance for emission cycle alignment without adding cost to the display.

The emission cycle information may be obtained from the display 220 using one or more communication protocols, such as Extended Display Identification Data (EDID) or DisplayPort Configuration Data (DPCD) communication protocols. The graphics processor 302 may query the display 220 to retrieve emission cycle frequency information and other timing parameters through the bidirectional connection. The communications may provide the emission cycle frequency of the OLED panel 222 to the graphics processor 302, enabling VRR synchronization 307 to calculate appropriate frame timing delays. The emission cycle frequency (F_em), may represent the frequency at which the OLED panel operates its emission cycles (e.g., 960 Hz). The emission cycle frequency may be obtained from the display through EDID or DPCD communication.

Display hardware delays and line buffer information may be communicated from the display 220 to the graphics processor 302 through one or more communications. The timing controller 230 may communicate sink delay information to the graphics processor 302, where the sink delay may include hardware delays and line buffer delays present in the timing controller 230. The display 220 may communicate line buffer information to the graphics processor 302, enabling calculation of the sink delay based on the line buffer characteristics. VRR synchronization 307 may use the sink delay information in calculating the time delay for frame updates.

The memory 310 may store instructions that, if executed by the processing circuitry 305, cause the graphics processor 302 to determine a number of elapsed emission cycles since a previously provided frame based on an elapsed time since the previously provided frame and an emission cycle frequency of the display 220. The processing circuitry 305 may determine a number of emission cycles per frame based on the emission cycle frequency and a frame rate of the display 220. The processing circuitry 305 may determine a time delay based on the number of elapsed emission cycles, the number of emission cycles per frame, and whether the number of elapsed emission cycles aligns with an emission cycle boundary. The processing circuitry 305 may provide, based on the time delay, a next frame to the display 220 to align the next frame with a next emission cycle boundary of the display 220.

As described above with reference to FIG. 2, the emission cycle information may be obtained from the display. In the system 300 of FIG. 3, VRR synchronization 307 may obtain the emission cycle information from the display 220 through the EDID or DPCD (or other) communication protocols to perform the hardware-based timing alignment calculations.

A system for source-side VRR synchronization may comprise a graphics processor and a display communicatively connected via a display interface. The graphics processor may comprise processing circuitry and memory storing VRR synchronization instructions. The display may comprise an OLED panel and a timing controller. The display interface may support bidirectional communication, enabling the graphics processor to transmit frame data to the display and receive emission cycle information from the display. In the system 200 of FIG. 2, the graphics processor 202 and the display 220 may be communicatively connected, with the graphics processor 202 comprising the processing circuitry 205 and the memory 210 storing the VRR synchronization 212, and the display 220 comprising the OLED panel 222 and the timing controller 230. In the system 300 of FIG. 3, the graphics processor 302 and the display 220 may be communicatively connected, with the graphics processor 302 comprising the processing circuitry 305, the VRR synchronization 307, and the memory 310. The system may operate without a frame buffer in the timing controller 230, with the graphics processor performing source-side synchronization to align frame updates with emission cycle boundaries of the OLED panel.

Referring to FIGS. 4A-4B, a method for source-side VRR synchronization for OLED displays is collectively shown as flowcharts 400 and 401. The method 400 may be performed by the graphics processor 202 of FIG. 2 or the graphics processor 302 of FIG. 3 to align frame updates with emission cycle boundaries of a display. The method 400 may begin at start 402, which initiates the frame timing synchronization process.

From 402, the method 400 may proceed to operation 404, where a new frame ready for display may be received. The operation 404 may represent the point at which the graphics processor or display engine receives notification that a frame is available for transmission to the display. The new frame may be generated by an operating system (OS) or an application and may be ready for display at a variable time relative to emission cycle boundaries of the display.

The method 400 may then move to operation 406, where a display timing delay from the timing controller may be determined. The display timing delay, referred to as T_sink_delay, may account for hardware delays in the display including any line buffer delays that may be present in the timing controller. T_sink_delay may equal a delay provided by the timing controller or otherwise determined, such as based on a number of line buffers in the timing controller, a maximum frame rate, and a number of vertical rows. For example, the T_sink_delay may be determined based on a number of line buffers in the timing controller divided by a product of a maximum frame rate and a number of vertical rows. For example, a timing controller with a 3-line buffer in a display with 1800 vertical rows operating at a maximum of 120 Hz may have a T_sink_delay of approximately 0.000014 seconds (14 microseconds). The display frame rate, referred to as F_frame, may represent the refresh rate of the display in Hz (e.g., 120 Hz). The frame time period, referred to as T_frame, may represent the duration of one complete frame cycle and may be calculated based on the display frame rate (F_frame). For example, the following equation may be used:

$$T\_frame = \frac{1}{F\_frame}$$

In the above, example, T_frame would be 1 divided by F_frame (e.g., 0.008333 seconds for a 120 Hz frame rate). The source delay, referred to as T_source_delay, may represent source-side hardware processing delays associated with the graphics processor (e.g., 0.000050 seconds or 50 microseconds).

Following operation 406, the method 400 may proceed to operation 408, where an elapsed time since a last frame update may be calculated. The elapsed time, referred to as T_elapsed, may be tracked by maintaining timestamps of frame update events. The system may maintain timestamps to track time since the last frame update for calculating elapsed time in the VRR synchronization algorithm. The elapsed time may be calculated as T_elapsed equals a current timestamp minus a last frame update timestamp. The number of emission cycles since the previous frame update may be determined further based on the elapsed time since provision of a previous frame to the display. The elapsed time (T_elapsed) may be calculated based on the following:

$$T\_elapsed = T\_current - T\_last \_update$$

where T_current is a current timestamp and T_last_update is timestamp of a last frame update.

With continued reference to FIG. 4A, the method 400 may then advance to operation 410, where a number of elapsed emission cycles may be determined. The emission cycle frequency (F_em) may represent the frequency at which the OLED panel operates its emission cycles (e.g., 960 Hz). The emission cycle frequency may be obtained from the display using one more communication protocols (e.g., EDID or DPCD communication). The number of elapsed emission cycles, referred to as N_em_elapsed, may be determined based on the elapsed time (T_elapsed) and an emission cycle frequency of the display (F_em). The number of elapsed emission cycles (N_em_elapsed) may be calculated based on the following:

$$N\_em \_elapsed = T\_elapsed \times F\_em$$

From operation 410, the method 400 may proceed to operation 412, which may be a decision point that checks whether N_em_elapsed is an integer. Determining the time delay (T_delay) may be based on whether the number of emission cycles is an integer. For example, operation 412 may distinguish between frame updates that occur at emission cycle boundaries (i.e., N_em_elapsed is an integer) and frame updates that occur mid-cycle (i.e., N_em_elapsed is not an integer). If N_em_elapsed is an integer, the frame update may have occurred at an emission cycle boundary. If N_em_elapsed is not an integer, the frame update may have occurred during an emission cycle. Because frame updates during variable refresh rate operation may arrive at any time relative to emission cycle boundaries, the product of the elapsed time (T_elapsed) and the emission cycle frequency (F_em) may produce either an integer value or a non-integer value. An integer value may indicate that the elapsed time corresponds to a complete number of emission cycles, meaning the frame update timing aligns with an emission cycle boundary. A non-integer value may indicate that the elapsed time includes a partial emission cycle, meaning the frame update timing falls between emission cycle boundaries. The emission cycle frequency (F_em), may represent the frequency at which the OLED panel operates its emission cycles (e.g., 960 Hz). The emission cycle frequency may be obtained from the display through EDID or DPCD communication.

If operation 412 determines that N_em_elapsed is an integer, the method 400 may proceed to operation 414, which may compare a number of elapsed emission cycles (N_em_elapsed) and a number of emission cycles per frame (N_em_per_frame). Operation 414 may check whether a number of elapsed emission cycles (N_em_elapsed) is less than the number of emission cycles per frame (N_em_per_frame). That is, it may be determined whether the number of emission cycles since the previous frame update (number of elapsed emission cycles (N_em_elapsed)) is within a single frame. The number of emission cycles per frame may be based on the emission cycle frequency (F_em) and a frame rate of the display (F_frame). For example, the number of emission cycles per frame (N_em_per_frame) may be calculated based on the following equation:

$$N\_em \_per \_frame = \frac{F\_em}{F\_frame}$$

If the condition at operation 414 is true (N_em_elapsed<N_em_per_frame), the method 400 may proceed to output A. If the condition at operation 414 is false (N_em_elapsed≥N_em_per_frame), the method 400 may proceed to output B.

If operation 412 determines that N_em_elapsed is not an integer, the method 400 may proceed to operation 416, which may similarly check whether N_em_elapsed<N_em_per_frame. If the condition at operation 416 is true, the method 400 may proceed to output C. If the condition at operation 416 is false (N_em_elapsed≥N_em_per_frame), the method 400 may proceed to output D. The outputs A, B, C, and D may represent different cases for calculating the appropriate delay time before submitting the frame to the display, ensuring that frame updates are aligned with emission cycle boundaries. The branching structure of the method 400 may enable handling of various timing scenarios that arise during variable refresh rate operation.

Turning to FIG. 4B, the method for VRR synchronization for OLED displays continues as flowchart 401. Here, example case-specific delay calculations and subsequent frame submission operations are shown. The flowchart 401 continues from FIG. 4A through four parallel branches labeled A, B, C, and D, each corresponding to a different timing scenario. The time delay may be further based on a source delay associated with the graphics processor (T_source_delay) and a sink delay associated with the display (T_sink_delay). The source delay may account for source-side hardware processing delays, for example, 0.000050 seconds (50 microseconds).

Operation 418 may represent Case 1, where an integer number of emission cycles have elapsed within the frame time. In Case 1, the number of emission cycles since the previous frame update is less than the number of emission cycles per frame. Operation 420 may calculate the delay (T_delay) as the following equation:

$$T\_delay = T\_frame - T\_elapsed - T\_source \_delay - T\_sink \_delay$$

T_frame is the duration of one complete frame cycle and may be calculated based on the display frame rate (F_frame). For example, the following equation may be used:

$$T\_frame = \frac{1}{F\_frame}$$

T_elapsed is the elapsed time and may be calculated based on the following:

$$T\_elapsed = T\_current - T\_last \_update$$

where T_current is a current timestamp and T_last_update is timestamp of a last frame update.

T_source_delay is the source delay corresponding to source-side hardware processing delays associated with the graphics processor (e.g., 0.000050 seconds or 50 microseconds). T_sink_delay is the display timing delay, which may account for hardware delays in the display including any line buffer delays that may be present in the timing controller. T_sink_delay may equal a delay provided by the timing controller or otherwise determined, such as based on a number of line buffers in the timing controller, a maximum frame rate, and a number of vertical rows. For example, the T_sink_delay may be determined based on a number of line buffers in the timing controller divided by a product of a maximum frame rate and a number of vertical rows.

Based on the number of emission cycles since the previous frame update being less than the number of emission cycles per frame, the time delay may align the next frame with an end of a current frame period. For example, for N_em_elapsed equal to 4 (an integer value within 8 emission cycles per frame), T_delay may equal 0.008333s−0.004167s−0.000050s−0.000014s, resulting in T_delay of 0.004102 seconds.

With continued reference to FIG. 4B, operation 422 may represent Case 2, where an integer number of emission cycles have elapsed beyond the frame time (N_em_elapsed≥N_em_per_frame). That is, the number of emission cycles since the previous frame update may be greater than or equal to the number of emission cycles per frame. Operation 424 may calculate the delay based on the emission cycle frequency (F_em), the source delay (T_source_delay), and the sink delay (T_sink_delay). For example, the T_delay may be calculated based on the following equation:

$$T\_delay = \frac{1}{F\_em} - T\_source \_delay - T\_sink \_delay$$

Based on the number of emission cycles since the previous frame update being greater than or equal to the number of emission cycles per frame, the time delay may align the next frame with a next emission cycle boundary. For example, for N_em_elapsed equal to 8 (an integer value at the frame boundary), T_delay may be 1/960-0.000050s−0.000014s, resulting in T_delay being 0.000978s.

Operation 426 may represent Case 3, where a non-integer number of emission cycles have elapsed within the frame time. In Case 3, the number of elapsed emission cycles may include a partial emission cycle and may be less than the number of emission cycles per frame (e.g., N_em_elapsed<N_em_per_frame). Operation 428 may determine the T_delay based the duration of one complete frame cycle (T_frame), the elapsed time (T_elapsed), source delay (T_source_delay) and the display timing delay (T_sink_delay). For example, the time delay (T_delay) may be calculated based on the following equation:

$$T\_delay = T\_frame - T\_elapsed - T\_source \_delay - T\_sink \_delay$$

Based on the number of elapsed emission cycles being less than the number of emission cycles per frame, the time delay may align the next frame with an end of a current frame period. For example, for N_em_elapsed equal to 4.2 (a non-integer value within the frame), T_delay may equal 0.008333s−0.004375s−0.000050s−0.000014s, resulting in T_delay being 0.003894s.

Operation 430 may represent Case 4, where a non-integer number of emission cycles have elapsed beyond the frame time (e.g., N_em_elapsed≥N_em_per_frame). In Case 4, the number of elapsed emission cycles may include a partial emission cycle and may be greater than or equal to the number of emission cycles per frame. Operation 432 may determine the T_delay based on the number of elapsed emission cycles (N_em_elapsed), emission cycle frequency (F_em), the elapsed time (T_elapsed), source delay (T_source_delay), and the display timing delay (T_sink_delay). The time delay (T_delay) may be calculated based on a ceiling of N_em_elapsed, where the “ceiling” operation is a rounding up of the value. For example, the time delay (T_delay) may be calculated based on the following equation:

$$T\_delay = \frac{⌈ N\_em \_elapsed ⌉}{F\_em} - T\_elapsed - T\_source \_delay - T\_sink \_delay$$

Based on the number of elapsed emission cycles including a partial emission cycle, the time delay may be based on a next whole number of emission cycles greater than the number of elapsed emission cycles. Based on the number of elapsed emission cycles being greater than or equal to the number of emission cycles per frame, the time delay may align the next frame with a next emission cycle boundary. For example, for N_em_elapsed equal to 11.1 (a non-integer value beyond the frame), T_delay may equal 12/960-0.011563s−0.000050s−0.000014s, resulting in T_delay being 0.000874s.

Following the delay calculations from all four cases, the method 401 may converge at operation 434, where the system may wait for the calculated T_delay duration. After the delay period has elapsed, operation 436 may submit the frame to the display. Subsequently, operation 438 may update the last frame update timestamp to track timing for subsequent frame submissions. The method 401 may then reach an end 440, completing the frame synchronization process for the current frame update cycle. The method 401 may repeat for each subsequent frame update to maintain consistent synchronization between frame updates and emission cycle boundaries during variable refresh rate operation.

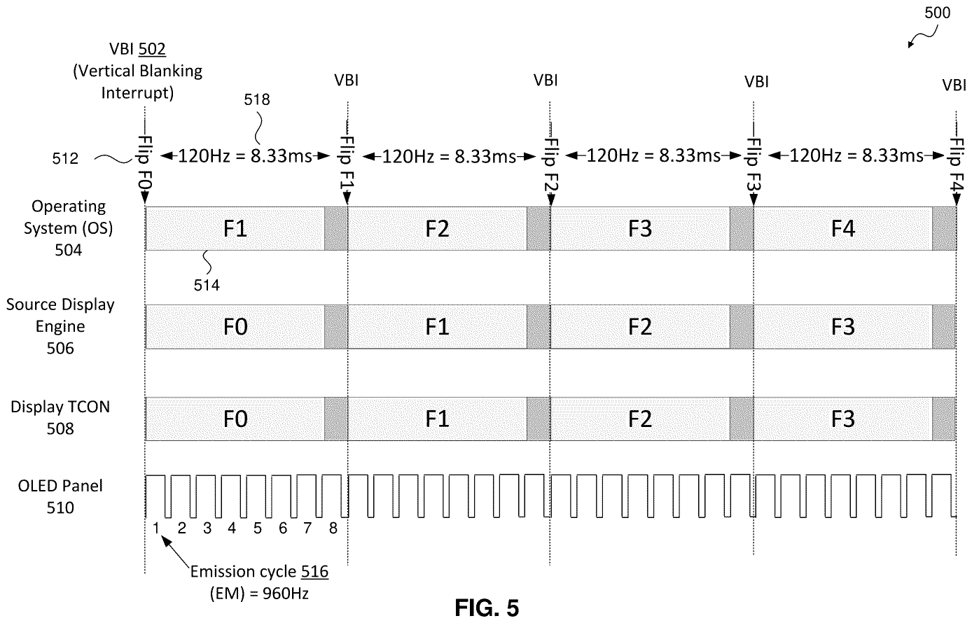

Referring to FIG. 5, a timing diagram 500 representing OLED display operation at a fixed refresh rate of 120 Hz with emission cycles operating at 960 Hz is shown. The timing diagram 500 may depict the temporal relationship between several layers of a display pipeline during fixed refresh rate operation. The timing diagram 500 may include an OS track 504, an SDE track 506, a Display Timing Controller (D-TCON) track 508, and an OLED panel track 510. Vertical Blanking Interrupt (VBI) events 502 are also shown.

The VBI 502 may show vertical blanking interrupt events that mark frame boundaries during display operation. The vertical blanking interrupt events may indicate the end of blanking or the start of a new frame. The operating system (OS) track 504 may show operating system frame preparation, where frames may be prepared during respective frame intervals before being presented at vertical blanking interrupt boundaries. The source display engine (SDE) track 506 may show source display engine (SDE) frame transmission, where frames may be transmitted from the graphics processor to the display. The D-TCON track 508 may show display timing controller frame reception, where frames may be received by the timing controller for output to the OLED panel.

With continued reference to FIG. 5, the OLED panel track 510 may display emission cycles 516 as a square wave pattern representing discrete light emission events characteristic of OLED display operation. The emission cycles 516 may operate at an emission cycle frequency of, for example, 960 Hz. Flip events 512 may mark frame boundaries where frames 514 transition from one frame to a subsequent frame. The frames 514 may include frames such as F0, F1, F2, F3, and F4, which may be prepared by the operating system and transmitted through the display pipeline.

The timing diagram 500 may show frame intervals 518 of, for example, 8.33 milliseconds corresponding to the 120 Hz refresh rate, but other refresh rates are possible. Within each frame interval 518, there may be eight emission cycles 516, as the emission cycle frequency of 960 Hz may result in eight emission cycles per frame time for a 120 Hz frame rate display. The number of emission cycles per frame may be calculated using the formula N_em_per_frame=F_em/F_frame, where F_em represents the emission cycle frequency and F_frame represents the frame rate. For a 960 Hz emission cycle frequency and a 120 Hz frame rate, N_em_per_frame may equal 8. The frame time period may be calculated using the formula T_frame=1/F_frame, which may result in a frame time of approximately 0.008333 seconds (8.33 milliseconds) for a 120 Hz frame rate.

The OLED panel may use Pulse Width Modulation (PWM) within each emission cycle 516 to control individual pixel brightness. PWM may determine the duty cycle of light emission for each pixel, where the duty cycle may represent the proportion of time during an emission cycle that a pixel emits light. By modulating the duty cycle within each emission cycle 516, the OLED panel may achieve varying brightness levels for individual pixels while maintaining the fixed emission cycle frequency. The human eye may perceive smooth, continuous brightness due to the high frequency of the emission cycles 516 exceeding a visual flicker fusion threshold.

In the fixed refresh rate operation shown in the timing diagram 500, frame updates from the operating system may be synchronized with vertical blanking interrupt events shown in the VBI track 502. The source display engine may transmit frames aligned with emission cycle boundaries of the OLED panel. The alignment between frame updates and emission cycles 516 at the OLED panel may ensure proper display operation without visual artifacts such as flickering or tearing during fixed refresh rate operation.

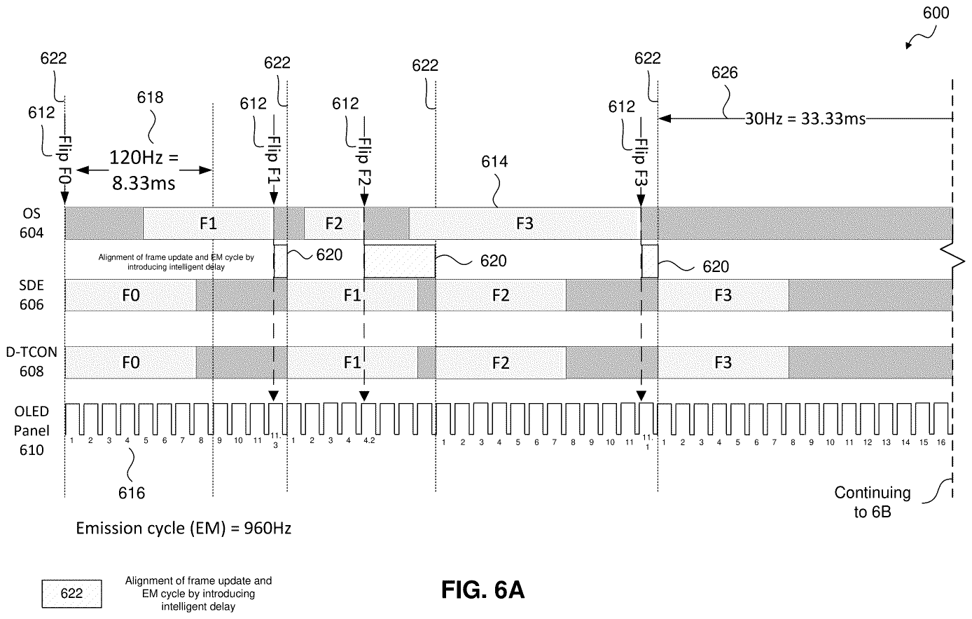

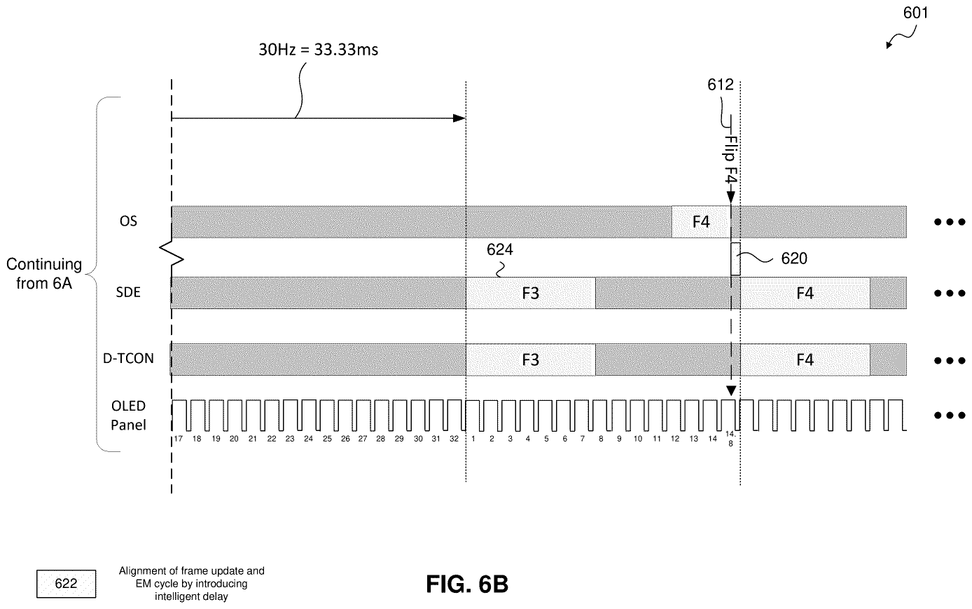

Referring to FIG. 6A, a timing diagram 600 representing frame update and emission cycle alignment during variable refresh rate operation is shown. The timing diagram 600 may depict the temporal relationships between multiple system layers during VRR operation on an OLED display. The timing diagram 600 may include an operating system (OS) track 604, a source display engine (SDE) track 606, a Display Timing Controller (D-TCON) track 608, and an OLED panel track 610.

The OS track 604 may show flip events 612 where frames become ready for display. The flip events 612 may represent points at which the operating system or an application signals that a frame is available for transmission to the display. The flip events 612 may include events such as Flip F0, Flip F1, Flip F2, and Flip F3, each indicating when a corresponding frame becomes ready. During variable refresh rate operation, the flip events 612 may occur at varying intervals rather than at fixed intervals, resulting in frame updates that may not align with emission cycle boundaries of the OLED panel.

With continued reference to FIG. 6A, the SDE track 606 may show frames 614 as processed by the source display engine. The frames 614 may include frames such as F0, F1, F2, and F3. The SDE track 606 may include delay periods 620, shown as hatched regions, representing intelligent delays introduced for emission cycle alignment. The delay periods 620 may represent time intervals during which the source display engine delays frame transmission to align frame updates with emission cycle boundaries. The delay periods 620 may be calculated using the VRR synchronization algorithm described with reference to FIGS. 4A-4B.

The D-TCON track 608 may show frames received by the timing controller after synchronization by the source display engine. The D-TCON track 608 may display the frames 614 as received from the source display engine, with the frames arriving at the timing controller at times aligned with emission cycle boundaries. Vertical dashed lines with arrows may indicate synchronization points between the SDE track 606 and the D-TCON track 608, showing where frame updates align with emission cycle boundaries.

The OLED panel track 610 may display emission cycles 616 as a series of pulses representing discrete light emission events. The emission cycles 616 may be numbered sequentially, with numbering sequences including values such as 1 through 11. The emission cycles 616 may also include fractional values such as 11.3 and 4.2, showing non-integer emission cycle boundaries where frame updates may occur during variable refresh rate operation. The fractional values may indicate that a frame update occurred at a point within an emission cycle rather than at an emission cycle boundary.

An EM cycle boundary 622 may mark the alignment point where a delayed frame update synchronizes with an emission cycle. The EM cycle boundary 622 may represent the point at which the source display engine releases a frame to the timing controller after applying the calculated delay. By aligning frame updates with the EM cycle boundary 622, the system may prevent visual artifacts that would otherwise occur when frame updates arrive mid-cycle.

A frame period 618 may represent the duration of each frame during variable refresh rate operation. The timing diagram 600 may indicate that the display operates at 120 Hz with a frame period 618 of, for example, 8.33 milliseconds, while also showing a 30 Hz period of 33.33 milliseconds for lower refresh rate scenarios. The frame period 618 may vary during variable refresh rate operation, with frames arriving at different intervals based on content rendering requirements.

As described above with reference to FIGS. 4A-4B, the time delay may be further based on a source delay associated with the graphics processor and a sink delay associated with the display. The sink delay may be based on line buffer information associated with the display. The timing controller may include small line buffers containing approximately three horizontal lines of pixel data to provide greater tolerance for emission cycle alignment timing. For a three-line buffer in a 2880×1800 display, the buffer fill and flush time may require approximately 0.000014 seconds (14 microseconds). The display may communicate line buffer information to the source, enabling calculation of the sink delay based on the specific timing controller configuration. The sink delay information may be communicated through EDID or DPCD communication protocols, as described above with reference to FIG. 3.

The timing diagram 600 may demonstrate how frames arriving at non-integer emission cycle boundaries may be delayed by the source-side processing to ensure proper alignment with the OLED emission cycles. By introducing the delay periods 620 at the source display engine, the system may maintain visual quality without requiring a frame buffer in the timing controller. The timing diagram 600 may continue to FIG. 6B, as indicated by a notation at the bottom right of the timing diagram 600.

Referring to FIG. 6B, a timing diagram 601 representing a continuation of the frame update and emission cycle alignment process from FIG. 6A is shown. The timing diagram 601 may depict operation at 30 Hz, corresponding to a frame period 618 of 33.33 milliseconds, and may show the temporal relationships between multiple system components during variable refresh rate operation on an OLED display at lower refresh rates.

The timing diagram 601 shows the OS track 604, the SDE track 606, the D-TCON track 608, and the OLED panel track 610 continuing from FIG. 6A. Again, the OS track 604 may show flip events 612 where frames become ready for display. The flip events 612 may include a Flip F4 event representing the point at which frame F4 becomes ready for display. The SDE track 606 may show frames 614 as processed by the source display engine, including frames F3 and F4. The D-TCON track 608 may show frames received by the timing controller, with frames F3 and F4 appearing in subsequent positions.

With continued reference to FIG. 6B, the timing diagram 601 may show a minimum refresh rate period 626 of 33.33 milliseconds corresponding to the 30 Hz minimum refresh rate. The minimum refresh rate period 626 may represent the maximum time interval between frame updates before frame repetition may be performed to prevent visual artifacts. For a display supporting a variable refresh rate range of 120 Hz to 30 Hz, the minimum refresh rate period 626 may equal 33.33 milliseconds (1 divided by 30 Hz).

If no new frame arrives within the minimum refresh rate period 626, the display engine may output a repeated frame 624 to prevent flicker. The repeated frame 624 may comprise the previous frame being displayed again to maintain continuous visual output on the OLED panel. In the timing diagram 601, frame F3 may be repeated as the repeated frame 624 if no new frame arrives within the minimum refresh rate period 626. By repeating the previous frame, the display engine may maintain the emission cycle pattern of the OLED panel without visual artifacts such as flickering that would otherwise occur if the panel received no frame data during an extended period. The timing diagram 601 may show delay periods 620 representing intelligent delays introduced for emission cycle alignment at lower refresh rates. The delay periods 620 may align frame updates with the EM cycle boundaries 622, ensuring that frames arrive at the timing controller at times synchronized with emission cycle boundaries of the OLED panel. The source-side synchronization may maintain proper alignment between frame updates and emission cycles even if operating at lower refresh rates such as 30 Hz.

Dotted vertical lines in the timing diagram 601 may indicate synchronization points where frame updates align with the EM cycle boundaries 622. The synchronization points may show where the source display engine releases frames to the timing controller after applying the calculated delays. By maintaining alignment with the EM cycle boundaries 622 at lower refresh rates, the system may prevent visual artifacts while enabling variable refresh rate operation across the full range of supported refresh rates from 30 Hz to 120 Hz.

A display pipeline architecture may include multiple processing stages between a graphics processor and a display panel. In some configurations, the display pipeline may include a graphics processing unit (GPU), a scaler, and a timing controller (TCON) arranged in a downstream sequence. The GPU may generate frame data and perform graphics processing operations. The scaler may receive frame data from the GPU and perform scaling operations to adjust the resolution or aspect ratio of the frame data to match the display panel characteristics. The TCON may receive frame data from the scaler and control the timing of pixel updates to the display panel.

In monitor display configurations, the scaler may be present between the GPU and the TCON. The scaler and the TCON may be located on a main board inside the monitor. The scaler may perform resolution conversion, aspect ratio adjustment, or other image processing operations before passing frame data to the TCON. The source-side VRR synchronization may be performed by the GPU before frame data is transmitted to the scaler, enabling the synchronization calculations to occur upstream of both the scaler and the TCON.

In laptop display configurations, the scaler may not be present in the display pipeline. The display pipeline in laptop configurations may include the GPU and the TCON without an intermediate scaler. Frame data may be transmitted directly from the GPU to the TCON without passing through a scaler. The source-side VRR synchronization may be performed by the GPU before frame data is transmitted to the TCON, enabling the synchronization calculations to occur upstream of the TCON.

The source-side VRR synchronization solution may apply to both laptop display configurations where scalers do not exist and monitor display configurations where scalers are present between the GPU and the TCON. In both configurations, the VRR synchronization calculations may be performed at the GPU level, upstream of any intermediate processing stages. By performing the synchronization at the GPU, the solution may accommodate different display pipeline architectures without requiring modifications to downstream components such as scalers or TCONs. The frame timing delays calculated by the GPU may account for processing delays introduced by any intermediate components in the display pipeline, including scaler processing delays in monitor configurations.

VRR synchronization described above may be extended to support fixed refresh rates that are not aligned with emission cycle boundaries. An OLED display may be designed to operate at a particular refresh rate that produces an integer number of emission cycles per frame, such as a 120 Hz refresh rate with 960 Hz emission cycles producing 8 emission cycles per frame. However, the same display may be operated at a different fixed refresh rate that does not produce an integer number of emission cycles per frame. In such configurations, the VRR synchronization algorithm may be applied to align frame updates with emission cycle boundaries even during fixed refresh rate operation.

For example, a display with 960 Hz emission cycles designed for 120 Hz operation may be operated at a fixed 70 Hz refresh rate. At 70 Hz, the number of emission cycles per frame may be calculated as

$$\frac{960}{70} \approx 13.71$$

emission cycles per frame. Because 13.71 is a non-integer value, frame updates at 70 Hz may not naturally align with emission cycle boundaries of the OLED panel. Without synchronization, frame updates may occur at points within emission cycles rather than at emission cycle boundaries, potentially causing visual artifacts.

The VRR synchronization algorithm may treat the non-aligned fixed refresh rate similarly to variable refresh rate operation. For each frame update at the 70 Hz fixed refresh rate, the algorithm may calculate the number of elapsed emission cycles since the previous frame update. Because the 70 Hz refresh rate produces a non-integer number of emission cycles per frame, the elapsed emission cycle count may include a fractional component. The algorithm may apply the same delay logic described above to align frame updates with emission cycle boundaries, calculating an appropriate delay to ensure that each frame arrives at the timing controller at an emission cycle boundary.

The delay calculation for non-EM cycle aligned fixed refresh rates may follow the same case-based logic as variable refresh rate operation. If the number of elapsed emission cycles includes a fractional component and is less than the number of emission cycles per frame, the delay may align the next frame with an end of a current frame period. If the number of elapsed emission cycles includes a fractional component and is greater than or equal to the number of emission cycles per frame, the delay may align the next frame with a next emission cycle boundary based on a ceiling function applied to the elapsed emission cycle count.

The extension to non-EM cycle aligned fixed refresh rates may enable OLED displays to operate at refresh rates beyond those for which the displays were originally designed. A display designed for 120 Hz operation with 8 emission cycles per frame may be operated at 70 Hz, 90 Hz, or other refresh rates that do not produce integer emission cycle counts. The 90 Hz refresh rate may produce approximately

$$\frac{960}{90} \approx 10.67$$

emission cycles per frame, which is also a non-integer value requiring the same synchronization approach. By applying the VRR synchronization algorithm, the source-side processing may maintain proper alignment between frame updates and emission cycles regardless of whether the operating refresh rate produces an integer or non-integer number of emission cycles per frame.

The source-side synchronization for non-EM cycle aligned fixed refresh rates may provide flexibility in display operation without requiring hardware modifications to the display. The timing controller may receive frame data at emission cycle boundaries regardless of the operating refresh rate, enabling the OLED panel to maintain proper emission cycle operation. The synchronization calculations may be performed by the graphics processor using the same algorithm and delay formulas applied during variable refresh rate operation, with the elapsed time between frame updates being determined by the fixed refresh rate rather than by variable frame generation timing.

The source-side VRR synchronization may support displays that operate at refresh rates as low as 1 Hz. Displays capable of operating at such low refresh rates may achieve power savings through the inherently low refresh rate operation rather than through separate power-saving mechanisms. By supporting refresh rates as low as 1 Hz, the source-side synchronization may enable removal of buffering hardware from premium low refresh rate displays.

Panel Self Refresh (PSR) and Panel Replay (PR) may be power-saving technologies that use frame buffers within a display to reduce power consumption. In PSR operation, a display may store a frame in a buffer and repeatedly refresh the display panel from the stored frame without requiring continuous frame transmission from a graphics processor. In PR operation, a display may similarly use buffered frame data to maintain display output while reducing data transmission from the source. Both PSR and PR may require frame buffer hardware within the display to store frame data for repeated display refresh operations.

Displays that can operate at refresh rates as low as 1 Hz may achieve power savings comparable to PSR or PR through the low refresh rate operation itself. At a 1 Hz refresh rate, the display may receive only one frame per second from the graphics processor, reducing data transmission and associated power consumption. The low refresh rate may reduce power consumption at both the source side and the display side by minimizing the frequency of frame transmission and display refresh operations.

The source-side VRR synchronization may enable displays operating at 1 Hz or other low refresh rates to maintain proper alignment between frame updates and emission cycle boundaries without requiring display-side frame buffers. The synchronization algorithm may calculate appropriate delays for frame updates at low refresh rates using the same case-based logic applied at higher refresh rates. For a 1 Hz refresh rate with 960 Hz emission cycles, the number of emission cycles per frame may be calculated as

$$\frac{960}{1} = 960$$

emission cycles per frame. The algorithm may align frame updates with emission cycle boundaries across the 1-second frame period.

By combining low refresh rate capability with source-side VRR synchronization, displays may achieve power savings without requiring PSR or PR buffering hardware. The elimination of PSR or PR buffering hardware may reduce manufacturing costs for premium displays that support low refresh rate operation. Displays designed for applications where static content is displayed for extended periods may benefit from the combination of low refresh rate operation and source-side synchronization, achieving both power savings and cost reduction through the elimination of display-side buffering hardware.

The source-side synchronization may support variable refresh rate operation across a range that includes both high refresh rates for dynamic content and low refresh rates for static content. A display may operate at 120 Hz or higher during active content rendering and transition to 1 Hz or other low refresh rates if displaying static content. The source-side synchronization may maintain proper emission cycle alignment across the full range of supported refresh rates, from 1 Hz to the maximum supported refresh rate of the display. By supporting the full refresh rate range through source-side synchronization, the display may eliminate the need for separate buffering hardware for both VRR operation and low refresh rate power savings.

A display system with source-side VRR synchronization may be configured by coupling processing circuitry (e.g., processing circuitry 205 or processing circuitry 305) to memory (e.g., memory 210 or memory 310) storing VRR synchronization instructions (e.g., VRR synchronization 212). The processing circuitry may be configured to communicate with a display (e.g., display 220) through a bidirectional connection to receive emission cycle information from the display. The emission cycle information may include an emission cycle frequency of an OLED panel (e.g., OLED panel 222) and may be received through one or more communication protocols, such as EDID or DPCD communication protocols. The processing circuitry may be further configured to calculate frame timing delays based on the received emission cycle information, including determining a number of elapsed emission cycles since a previous frame update, comparing the number of elapsed emission cycles to a number of emission cycles per frame, and calculating a time delay to align a next frame with an emission cycle boundary of the display. The processing circuitry may be configured with dedicated hardware logic (e.g., VRR synchronization 307) to perform the timing alignment calculations. The display may be configured without a frame buffer in the timing controller (e.g., timing controller 230), with the source-side VRR synchronization providing the frame timing alignment that would otherwise be performed by a display-side frame buffer.

The source-side VRR synchronization may be detectable through analysis of the display interface. For example, monitoring of communication (e.g., EDID or DPCD communication) between the graphics processor and the display may reveal the exchange of emission cycle frequency information and sink delay parameters. Timing analysis of the display link signal may reveal that frame data transmissions are consistently aligned with emission cycle boundaries of the OLED panel, with variable delays between frame ready events and frame transmissions corresponding to the calculated time delays. The absence of a frame buffer in the timing controller of the display may be verified through inspection of the display hardware. The combination of source-side frame timing delays observable at the display interface and the absence of display-side frame buffering hardware may indicate the use of source-side VRR synchronization.

### Examples

The following examples pertain to various techniques described herein.

An example (e.g., example 1) is an apparatus comprising: one or more processors configured to: determine, based on emission cycle information of a display, a number of emission cycles since a previous frame update; determine a time delay based on the number of emission cycles; and provide, based on the determined time delay, a next frame to the display to align the next frame with an emission cycle boundary of the display.

Another example (e.g., example 2) is an apparatus comprising: one or more processors; and memory storing instructions that, if executed by the one or more processors, cause the apparatus to: determine, based on emission cycle information of a display, a number of emission cycles since a previous frame update; determine a time delay based on the number of emission cycles; and provide, based on the determined time delay, a next frame to the display to align the next frame with an emission cycle boundary of the display.

Another example (e.g., example 3) relates to a previously-described example (e.g., one or more of examples 1-2), wherein the number of emission cycles since the previous frame update is determined further based on an elapsed time since provision of a previous frame to the display.

Another example (e.g., example 4) relates to a previously-described example (e.g., one or more of examples 1-3), wherein the emission cycle information comprises an emission cycle frequency of the display.

Another example (e.g., example 5) relates to a previously-described example (e.g., example 4), wherein the emission cycle frequency is of an organic light-emitting diode (OLED) panel of the display.

Another example (e.g., example 6) relates to a previously-described example (e.g., one or more of examples 1-5), wherein the emission cycle information is obtained from the display.

Another example (e.g., example 7) relates to a previously-described example (e.g., one or more of examples 1-6), wherein the time delay is further based on a source delay associated with the apparatus and a sink delay associated with the display.

Another example (e.g., example 8) relates to a previously-described example (e.g., example 7), wherein the sink delay is based on line buffer information associated with the display.

Another example (e.g., example 9) relates to a previously-described example (e.g., one or more of examples 1-8), wherein determining the time delay is based on whether the number of emission cycles is an integer.

Another example (e.g., example 10) relates to a previously-described example (e.g., one or more of examples 1-9), wherein determining the time delay is further based on a number of emission cycles per frame.

Another example (e.g., example 11) relates to a previously-described example (e.g., example 10), wherein determining the time delay is based on a comparison of the number of emission cycles since the previous frame update and the number of emission cycles per frame.

Another example (e.g., example 12) relates to a previously-described example (e.g., one or more of examples 1-11), wherein the time delay is determined based on whether the number of emission cycles since the previous frame update is within a single frame.

Another example (e.g., example 13) relates to a previously-described example (e.g., one or more of examples 1-12), wherein: based on the number of emission cycles since the previous frame update being less than a number of emission cycles per frame, the time delay aligns the next frame with an end of a current frame period; and based on the number of emission cycles since the previous frame update being greater than or equal to the number of emission cycles per frame, the time delay aligns the next frame with a next emission cycle boundary.

Another example (e.g., example 14) relates to a previously-described example (e.g., one or more of examples 1-13), wherein determining the time delay comprises determining whether the number of emission cycles since the previous frame update is less than a number of emission cycles per frame, wherein the number of emission cycles per frame is based on an emission cycle frequency and a frame rate of the display.

Another example (e.g., example 15) is an apparatus comprising: one or more processors configured to: determine a number of elapsed emission cycles since a previously provided frame based on an elapsed time since the previously provided frame and an emission cycle frequency of a display; determine a number of emission cycles per frame based on the emission cycle frequency and a frame rate of the display; determine a time delay based on the number of elapsed emission cycles, the number of emission cycles per frame, and whether the number of elapsed emission cycles aligns with an emission cycle boundary; and provide, based on the time delay, a next frame to the display to align the next frame with a next emission cycle boundary of the display.

Another example (e.g., example 16) is an apparatus comprising: one or more processors; and memory storing instructions that, if executed by the one or more processors, cause the apparatus to: determine a number of elapsed emission cycles since a previously provided frame based on an elapsed time since the previously provided frame and an emission cycle frequency of a display; determine a number of emission cycles per frame based on the emission cycle frequency and a frame rate of the display; determine a time delay based on the number of elapsed emission cycles, the number of emission cycles per frame, and whether the number of elapsed emission cycles aligns with an emission cycle boundary; and provide, based on the time delay, a next frame to the display to align the next frame with a next emission cycle boundary of the display.

Another example (e.g., example 17) relates to a previously-described example (e.g., one or more of examples 15-16), wherein the time delay is further based on a source delay associated with the apparatus and a sink delay associated with the display.

Another example (e.g., example 18) relates to a previously-described example (e.g., one or more of examples 15-17), wherein: based on the number of elapsed emission cycles being less than the number of emission cycles per frame, the time delay aligns the next frame with an end of a current frame period; and based on the number of elapsed emission cycles being greater than or equal to the number of emission cycles per frame, the time delay aligns the next frame with a next emission cycle boundary.

Another example (e.g., example 19) relates to a previously-described example (e.g., one or more of examples 15-18), wherein: based on the number of elapsed emission cycles aligning with an emission cycle boundary, the time delay is based on the emission cycle frequency; and based on the number of elapsed emission cycles including a partial emission cycle, the time delay is based on a next whole number of emission cycles greater than the number of elapsed emission cycles.

Another example (e.g., example 20) is an apparatus comprising: means for determining, based on emission cycle information of a display, a number of emission cycles since a previous frame update; means for determining a time delay based on the number of emission cycles; and means for providing, based on the determined time delay, a next frame to the display to align the next frame with an emission cycle boundary of the display.

Another example (e.g., example 21) is an apparatus comprising: processing means; and storage means for storing instructions that, if executed by the processing means, cause the apparatus to: determine, based on emission cycle information of a display, a number of emission cycles since a previous frame update; determine a time delay based on the number of emission cycles; and provide, based on the determined time delay, a next frame to the display to align the next frame with an emission cycle boundary of the display.

Another example (e.g., example 22) is an apparatus comprising: processing means for: determining, based on emission cycle information of a display, a number of emission cycles since a previous frame update; determining a time delay based on the number of emission cycles; and providing, based on the determined time delay, a next frame to the display to align the next frame with an emission cycle boundary of the display.

Another example (e.g., example 23) relates to a previously-described example (e.g., one or more of examples 20-22), wherein the number of emission cycles since the previous frame update is determined further based on an elapsed time since provision of a previous frame to the display.

Another example (e.g., example 24) relates to a previously-described example (e.g., one or more of examples 20-23), wherein the emission cycle information comprises an emission cycle frequency of the display.

Another example (e.g., example 25) relates to a previously-described example (e.g., example 24), wherein the emission cycle frequency is of an organic light-emitting diode (OLED) panel of the display.

Another example (e.g., example 26) relates to a previously-described example (e.g., one or more of examples 20-25), wherein the emission cycle information is obtained from the display.

Another example (e.g., example 27) relates to a previously-described example (e.g., one or more of examples 20-26), wherein the time delay is further based on a source delay associated with the apparatus and a sink delay associated with the display.

Another example (e.g., example 28) relates to a previously-described example (e.g., example 27), wherein the sink delay is based on line buffer information associated with the display.

Another example (e.g., example 29) relates to a previously-described example (e.g., one or more of examples 20-28), wherein determining the time delay is based on whether the number of emission cycles is an integer.

Another example (e.g., example 30) relates to a previously-described example (e.g., one or more of examples 20-29), wherein determining the time delay is further based on a number of emission cycles per frame.

Another example (e.g., example 31) relates to a previously-described example (e.g., example 30), wherein determining the time delay is based on a comparison of the number of emission cycles since the previous frame update and the number of emission cycles per frame.

Another example (e.g., example 32) relates to a previously-described example (e.g., one or more of examples 20-31), wherein the time delay is determined based on whether the number of emission cycles since the previous frame update is within a single frame.

Another example (e.g., example 33) relates to a previously-described example (e.g., one or more of examples 20-32), wherein: based on the number of emission cycles since the previous frame update being less than a number of emission cycles per frame, the time delay aligns the next frame with an end of a current frame period; and based on the number of emission cycles since the previous frame update being greater than or equal to the number of emission cycles per frame, the time delay aligns the next frame with a next emission cycle boundary.

Another example (e.g., example 34) relates to a previously-described example (e.g., one or more of examples 20-33), wherein determining the time delay comprises determining whether the number of emission cycles since the previous frame update is less than a number of emission cycles per frame, wherein the number of emission cycles per frame is based on an emission cycle frequency and a frame rate of the display.

Another example (e.g., example 35) is an apparatus comprising: means for determining a number of elapsed emission cycles since a previously provided frame based on an elapsed time since the previously provided frame and an emission cycle frequency of a display; means for determining a number of emission cycles per frame based on the emission cycle frequency and a frame rate of the display; means for determining a time delay based on the number of elapsed emission cycles, the number of emission cycles per frame, and whether the number of elapsed emission cycles aligns with an emission cycle boundary; and means for providing, based on the time delay, a next frame to the display to align the next frame with a next emission cycle boundary of the display.

Another example (e.g., example 36) is an apparatus comprising: processing means; and storage means for storing instructions that, if executed by the processing means, cause the apparatus to: determine a number of elapsed emission cycles since a previously provided frame based on an elapsed time since the previously provided frame and an emission cycle frequency of a display; determine a number of emission cycles per frame based on the emission cycle frequency and a frame rate of the display; determine a time delay based on the number of elapsed emission cycles, the number of emission cycles per frame, and whether the number of elapsed emission cycles aligns with an emission cycle boundary; and provide, based on the time delay, a next frame to the display to align the next frame with a next emission cycle boundary of the display.

Another example (e.g., example 37) is an apparatus comprising: processing means for: determining a number of elapsed emission cycles since a previously provided frame based on an elapsed time since the previously provided frame and an emission cycle frequency of a display; determining a number of emission cycles per frame based on the emission cycle frequency and a frame rate of the display; determining a time delay based on the number of elapsed emission cycles, the number of emission cycles per frame, and whether the number of elapsed emission cycles aligns with an emission cycle boundary; and providing, based on the time delay, a next frame to the display to align the next frame with a next emission cycle boundary of the display.

Another example (e.g., example 38) relates to a previously-described example (e.g., one or more of examples 35-37), wherein the time delay is further based on a source delay associated with the apparatus and a sink delay associated with the display.

Another example (e.g., example 39) relates to a previously-described example (e.g., one or more of examples 35-38), wherein: based on the number of elapsed emission cycles being less than the number of emission cycles per frame, the time delay aligns the next frame with an end of a current frame period; and based on the number of elapsed emission cycles being greater than or equal to the number of emission cycles per frame, the time delay aligns the next frame with a next emission cycle boundary.

Another example (e.g., example 40) relates to a previously-described example (e.g., one or more of examples 35-39), wherein: based on the number of elapsed emission cycles aligning with an emission cycle boundary, the time delay is based on the emission cycle frequency; and based on the number of elapsed emission cycles including a partial emission cycle, the time delay is based on a next whole number of emission cycles greater than the number of elapsed emission cycles.

Another example (e.g., example 41) is a non-transitory computer-readable medium configured to store instructions that, if executed by one or more processors, cause an apparatus to: determine a number of elapsed emission cycles since a previously provided frame based on an elapsed time since the previously provided frame and an emission cycle frequency of a display; determine a number of emission cycles per frame based on the emission cycle frequency and a frame rate of the display; determine a time delay based on the number of emission cycles elapsed and the number of emission cycles per frame; and provide, based on the time delay, a next frame to the display to align the next frame with an emission cycle boundary of the display.

Another example (e.g., example 42) relates to a previously-described example (e.g., example 41), wherein the time delay is further based on a source delay associated with the apparatus and a sink delay associated with the display.

Another example (e.g., example 43) relates to a previously-described example (e.g., one or more of examples 41-42), wherein: based on the number of elapsed emission cycles being less than the number of emission cycles per frame, the time delay aligns the next frame with an end of a current frame period; and based on the number of elapsed emission cycles being greater than or equal to the number of emission cycles per frame, the time delay aligns the next frame with a next emission cycle boundary.

Another example (e.g., example 44) is a method comprising: determining, based on emission cycle information of a display, a number of emission cycles since a previous frame update; determining a time delay based on the number of emission cycles; and providing, based on the determined time delay, a next frame to the display to align the next frame with an emission cycle boundary of the display.

Another example (e.g., example 45) relates to a previously-described example (e.g., example 44), wherein the number of emission cycles since the previous frame update is determined further based on an elapsed time since provision of a previous frame to the display.

Another example (e.g., example 46) relates to a previously-described example (e.g., one or more of examples 44-45), wherein the emission cycle information comprises an emission cycle frequency of the display.

Another example (e.g., example 47) relates to a previously-described example (e.g., example 46), wherein the emission cycle frequency is of an organic light-emitting diode (OLED) panel of the display.

Another example (e.g., example 48) relates to a previously-described example (e.g., one or more of examples 44-47), wherein the emission cycle information is obtained from the display.

Another example (e.g., example 49) relates to a previously-described example (e.g., one or more of examples 44-48), wherein the time delay is further based on a source delay associated with the apparatus and a sink delay associated with the display.

Another example (e.g., example 50) relates to a previously-described example (e.g., example 49), wherein the sink delay is based on line buffer information associated with the display.

Another example (e.g., example 51) relates to a previously-described example (e.g., one or more of examples 44-50), wherein determining the time delay is based on whether the number of emission cycles is an integer.

Another example (e.g., example 52) relates to a previously-described example (e.g., one or more of examples 44-51), wherein determining the time delay is further based on a number of emission cycles per frame.

Another example (e.g., example 53) relates to a previously-described example (e.g., example 52), wherein determining the time delay is based on a comparison of the number of emission cycles since the previous frame update and the number of emission cycles per frame.

Another example (e.g., example 54) relates to a previously-described example (e.g., one or more of examples 44-53), wherein the time delay is determined based on whether the number of emission cycles since the previous frame update is within a single frame.

Another example (e.g., example 55) relates to a previously-described example (e.g., one or more of examples 44-54), wherein: based on the number of emission cycles since the previous frame update being less than a number of emission cycles per frame, the time delay aligns the next frame with an end of a current frame period; and based on the number of emission cycles since the previous frame update being greater than or equal to the number of emission cycles per frame, the time delay aligns the next frame with a next emission cycle boundary.

Another example (e.g., example 56) relates to a previously-described example (e.g., one or more of examples 44-55), wherein determining the time delay comprises determining whether the number of emission cycles since the previous frame update is less than a number of emission cycles per frame, wherein the number of emission cycles per frame is based on an emission cycle frequency and a frame rate of the display.

Another example (e.g., example 57) is a method comprising: determining a number of elapsed emission cycles since a previously provided frame based on an elapsed time since the previously provided frame and an emission cycle frequency of a display; determining a number of emission cycles per frame based on the emission cycle frequency and a frame rate of the display; determining a time delay based on the number of elapsed emission cycles, the number of emission cycles per frame, and whether the number of elapsed emission cycles aligns with an emission cycle boundary; and providing, based on the time delay, a next frame to the display to align the next frame with a next emission cycle boundary of the display.

Another example (e.g., example 58) relates to a previously-described example (e.g., example 57), wherein the time delay is further based on a source delay associated with the apparatus and a sink delay associated with the display.

Another example (e.g., example 59) relates to a previously-described example (e.g., one or more of examples 57-58), wherein: based on the number of elapsed emission cycles being less than the number of emission cycles per frame, the time delay aligns the next frame with an end of a current frame period; and based on the number of elapsed emission cycles being greater than or equal to the number of emission cycles per frame, the time delay aligns the next frame with a next emission cycle boundary.

Another example (e.g., example 60) relates to a previously-described example (e.g., one or more of examples 57-59), wherein: based on the number of elapsed emission cycles aligning with an emission cycle boundary, the time delay is based on the emission cycle frequency; and based on the number of elapsed emission cycles including a partial emission cycle, the time delay is based on a next whole number of emission cycles greater than the number of elapsed emission cycles.

Another example (e.g., example 61) is a method comprising: determining a number of elapsed emission cycles since a previously provided frame based on an elapsed time since the previously provided frame and an emission cycle frequency of a display; determining a number of emission cycles per frame based on the emission cycle frequency and a frame rate of the display; determining a time delay based on the number of emission cycles elapsed and the number of emission cycles per frame; and providing, based on the time delay, a next frame to the display to align the next frame with an emission cycle boundary of the display.

Another example (e.g., example 62) relates to a previously-described example (e.g., example 61), wherein the time delay is further based on a source delay associated with the apparatus and a sink delay associated with the display.

Another example (e.g., example 63) relates to a previously-described example (e.g., one or more of examples 61-62), wherein: based on the number of elapsed emission cycles being less than the number of emission cycles per frame, the time delay aligns the next frame with an end of a current frame period; and based on the number of elapsed emission cycles being greater than or equal to the number of emission cycles per frame, the time delay aligns the next frame with a next emission cycle boundary.

Another example (e.g., example 64) is at least one non-transitory computer-readable medium comprising instructions stored thereon, that if executed by one or more processors, cause the one or more processors to perform the operations of any of examples 44-63.

Another example (e.g., example 65) is an apparatus comprising: one or more processors; and memory storing instructions that, if executed by the one or more processors, cause the apparatus to perform the operations of any of examples 44-63.

Another example (e.g., example 66) is an apparatus as shown and described.

Another example (e.g., example 67) is a method as shown and described.

Another example (e.g., example 68) is one or more non-transitory computer-readable media as shown and described.

### CONCLUSION

The aforementioned description will so fully reveal the general nature of the implementations described that others can, by applying knowledge within the skill of the art, readily modify and/or adapt for various applications such specific implementations without undue experimentation and without departing from the general concept as described. Therefore, such adaptations and modifications are intended to be within the meaning and range of equivalents of the described implementations, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

Each implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to affect such feature, structure, or characteristic in connection with other implementations whether or not explicitly described.

The exemplary implementations described herein are provided for illustrative purposes, and are not limiting. Other implementations are possible, and modifications may be made to the exemplary implementations. Therefore, the specification is not meant to be limiting. Rather, the scope is defined only in accordance with the following claims and their equivalents. Throughout the drawings, it should be noted that like reference numbers are used to depict the same or similar elements, features, and structures, unless otherwise noted.

The terms “at least one” and “one or more” may be understood to include a numerical quantity greater than or equal to one (e.g., one, two, three, four, [ . . . ], etc.). The term “a plurality” may be understood to include a numerical quantity greater than or equal to two (e.g., two, three, four, five, [ . . . ], etc.).

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. The terms “group (of)”, “set (of)”, “collection (of)”, “series (of)”, “sequence (of)”, “grouping (of)”, etc., and the like in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The phrase “at least one of” with regard to a group of elements may be used herein to mean at least one element from the group consisting of the elements. The phrase “at least one of” with regard to a group of elements may be used herein to mean a selection of: one of the listed elements, a plurality of one of the listed elements, a plurality of individual listed elements, or a plurality of a multiple of individual listed elements.

The terms “processor,” “processing circuitry,” or “controller” as used herein may be understood as any kind of technological entity that allows handling of data. The data may be handled according to one or more specific functions executed by the processor, processing circuitry, or controller. Further, processing circuitry, a processor, or a controller as used herein may be understood as any kind of circuit, e.g., any kind of analog or digital circuit. Processing circuitry, a processor, or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as processing circuitry, a processor, controller, or logic circuit. It is understood that any two (or more) of the processors, controllers, logic circuits, or processing circuitries detailed herein may be realized as a single entity with equivalent functionality or the like, and conversely that any single processor, controller, logic circuit, or processing circuitry detailed herein may be realized as two (or more) separate entities with equivalent functionality or the like.

As used herein, “memory” is understood as a computer-readable medium in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, among others, or any combination thereof. Registers, shift registers, processor registers, data buffers, among others, are also embraced herein by the term memory. The term “software” refers to any type of executable instruction, including firmware.

In one or more of the implementations described herein, processing circuitry can include memory that stores data and/or instructions. The memory can be any well-known volatile and/or non-volatile memory, including read-only memory (ROM), random access memory (RAM), flash memory, a magnetic storage media, an optical disc, erasable programmable read only memory (EPROM), and programmable read only memory (PROM). The memory can be non-removable, removable, or a combination of both.

1. An apparatus comprising:
one or more processors configured to:
determine, based on emission cycle information of a display, a number of emission cycles since a previous frame update;
determine a time delay based on the number of emission cycles; and
provide, based on the determined time delay, a next frame to the display to align the next frame with an emission cycle boundary of the display.

2. The apparatus of claim 1, wherein the number of emission cycles since the previous frame update is determined further based on an elapsed time since provision of a previous frame to the display.

3. The apparatus of claim 1, wherein the emission cycle information comprises an emission cycle frequency of the display.

4. The apparatus of claim 3, wherein the emission cycle frequency is of an organic light-emitting diode (OLED) panel of the display.

5. The apparatus of claim 1, wherein the emission cycle information is obtained from the display.

6. The apparatus of claim 1, wherein the time delay is further based on a source delay associated with the apparatus and a sink delay associated with the display.

7. The apparatus of claim 6, wherein the sink delay is based on line buffer information associated with the display.

8. The apparatus of claim 1, wherein determining the time delay is based on whether the number of emission cycles is an integer.

9. The apparatus of claim 1, wherein determining the time delay is further based on a number of emission cycles per frame.

10. The apparatus of claim 9, wherein determining the time delay is based on a comparison of the number of emission cycles since the previous frame update and the number of emission cycles per frame.

11. The apparatus of claim 1, wherein the time delay is determined based on whether the number of emission cycles since the previous frame update is within a single frame.

12. The apparatus of claim 1, wherein:
based on the number of emission cycles since the previous frame update being less than a number of emission cycles per frame, the time delay aligns the next frame with an end of a current frame period; and
based on the number of emission cycles since the previous frame update being greater than or equal to the number of emission cycles per frame, the time delay aligns the next frame with a next emission cycle boundary.

13. The apparatus of claim 1, wherein determining the time delay comprises determining whether the number of emission cycles since the previous frame update is less than a number of emission cycles per frame, wherein the number of emission cycles per frame is based on an emission cycle frequency and a frame rate of the display.

14. A non-transitory computer-readable medium configured to store instructions that, if executed by one or more processors, cause an apparatus to:
determine a number of elapsed emission cycles since a previously provided frame based on an elapsed time since the previously provided frame and an emission cycle frequency of a display;
determine a number of emission cycles per frame based on the emission cycle frequency and a frame rate of the display;
determine a time delay based on the number of emission cycles elapsed and the number of emission cycles per frame; and
provide, based on the time delay, a next frame to the display to align the next frame with an emission cycle boundary of the display.

15. The non-transitory computer-readable medium of claim 14, wherein the time delay is further based on a source delay associated with the apparatus and a sink delay associated with the display.

16. The non-transitory computer-readable medium of claim 14, wherein:
based on the number of elapsed emission cycles being less than the number of emission cycles per frame, the time delay aligns the next frame with an end of a current frame period; and
based on the number of elapsed emission cycles being greater than or equal to the number of emission cycles per frame, the time delay aligns the next frame with a next emission cycle boundary.

17. An apparatus comprising:
one or more processors configured to:
determine a number of elapsed emission cycles since a previously provided frame based on an elapsed time since the previously provided frame and an emission cycle frequency of a display;
determine a number of emission cycles per frame based on the emission cycle frequency and a frame rate of the display;
determine a time delay based on the number of elapsed emission cycles, the number of emission cycles per frame, and whether the number of elapsed emission cycles aligns with an emission cycle boundary; and
provide, based on the time delay, a next frame to the display to align the next frame with a next emission cycle boundary of the display.

18. The apparatus of claim 17, wherein the time delay is further based on a source delay associated with the apparatus and a sink delay associated with the display.

19. The apparatus of claim 17, wherein:
based on the number of elapsed emission cycles being less than the number of emission cycles per frame, the time delay aligns the next frame with an end of a current frame period; and
based on the number of elapsed emission cycles being greater than or equal to the number of emission cycles per frame, the time delay aligns the next frame with a next emission cycle boundary.

20. The apparatus of claim 17, wherein:
based on the number of elapsed emission cycles aligning with an emission cycle boundary, the time delay is based on the emission cycle frequency; and
based on the number of elapsed emission cycles including a partial emission cycle, the time delay is based on a next whole number of emission cycles greater than the number of elapsed emission cycles.
